(19) United States
(12) Patent Application Publication
(10) Pub. No.: US 2020/0008518 A1
(43) Pub. Date: Jan. 9, 2020

(54) NON-SLIP SOLE

(71) Applicant: COMPAGNIE GENERALE DES ETABLISSEMENTS MICHELIN, Clermont-Ferrand (FR)

(72) Inventors: PHILIPPE SOUYRI, Clermont-Ferrand (FR); BOZENA VOGE, Clermont-Ferrand (FR); EMMANUEL IGIER, Clermont-Ferrand (FR); PATRICIA MARSOLLIER, Clermont-Ferrand (FR)

(21) Appl. No.: 16/491,732

(22) PCT Filed: Mar. 6, 2018
(86) PCT No.: PCT/IB2018/051441

§ 371 Date: Sep. 6, 2019

(30) Foreign Application Priority Data
Mar. 8, 2017 (FR) 17/70223

(51) Int. Cl. A43B 13/02; A43B 13/22

(52) U.S. Cl. CPC A43B 13/02; C08L 101/00; A43B 13/22

(57) ABSTRACT

Shoe sole (1) comprising an outsole (2), an insole (4) and a midsole (3), extending between the insole (4) and the outsole (2), the outsole (2) being made of an elastomer material comprising a plurality of cavities (5) filled with cavity-filling particles (6) which are in the solid state at ambient temperature.

### TECHNICAL FIELD OF THE INVENTION

The present invention relates to a non-slip sole. It relates more particularly to a sole comprising a plurality of cavities which are occupied by filling particles. The invention also relates to a method for manufacturing such a sole.

### PRIOR ART

Numerous types of footwear sole provided with non-slip properties are known at the present time.

For example, document FR2843685 is known and describes an aquatic shoe provided with a rough underside surface. This surface has a non-slip surface finish made of an elastic fabric coated in a thin layer of rubbery material.

Document FR 2722376 is also known and relates to a non-slip surface of the type comprising a network of treadlike patterns in relief. The solution described consists in the fact that the said treadlike patterns are formed of a transverse network of narrow channels extending discontinuously from one edge to the other, a channel being defined by U-shaped lines.

Document FR2709929 describes a non-slip sole comprising teeth projecting from the sole and elastic pads likewise projecting and extending between the teeth and having a height at rest substantially equal to that of the teeth.

Document FR2661322 relates to a rigid sole made of polyvinyl chloride (PVC), of the type comprising a sole body equipped with at least one insert in contact with the ground and forming a wearing surface. The inserts are made of polyvinyl chloride with a hardness that is not as high as that of the polyvinyl chloride used in the body of the sole.

All of these solutions have a point in common: the effectiveness of the non-slip means degrades as the sole gradually wears.

There is therefore still a need for a sole having non-slip properties that are effective and durable despite the wearing of the sole.

### SUMMARY OF THE INVENTION

First of all, a first object of the invention is to provide a sole provided with friction characteristics that confer good non-slip characteristics, particularly on very smooth ground, on wet ground, or on dry or wet ice.

Another object of the invention is to provide a non-slip sole for a shoe the non-slip characteristics of which endure, despite the wearing of the sole.

In order to achieve this, the invention proposes a shoe sole comprising an outsole, an insole and a midsole, extending between the insole and the outsole, the outsole being made of an elastomer material comprising a plurality of cavities filled with cavity-filling particles which are in the solid state at ambient temperature, a plurality of open cavities forming micro-reliefs distributed over the external surface of the outsole when new, and during wearing of the sole, because of the way the cavities are distributed through the mass thereof, new cavities progressively coming to light.

The micro-reliefs generated by the cavity portions present at the surface of the sole afford a mechanical effect that increases the coefficient of friction of the sole. This effect is particularly advantageous on smooth ground, on wet or damp ground, and even on ice (dry or wet).

When the sole is new, a plurality of cavities are present at the surface, increasing the coefficient of friction of the sole. During wear, because the cavities are distributed through the mass of the sole, new cavities progressively come to light, ensuring that the favourable coefficient of friction is maintained. An effect is thus produced whereby the cavities self-regenerate, ensuring durability of the grip properties in spite of the wearing of the sole.

In addition to the advantages connected with the non-slip performance, unlike foam soles which are compressible, the soles according to the invention form an incompressible structure, affording numerous advantages in terms of mechanical behaviour.

According to one advantageous embodiment, the cavity filling particles are water-soluble. This embodiment makes it possible to create a sole of which the surface in contact with the ground is strewn with microcavities affording a ground-gripping effect. As soon as the sole begins to wear, new cavities and particles come to light in order to allow the grip properties associated with the cavities to remain continuous.

Advantageously, the filling particles are salts. This type of particles offers the advantage of great ease of mixing with the elastomer materials.

According to one advantageous embodiment, the filling particles are selected from the list including chlorates or perchlorates, or sulfates of potassium, ammonium or magnesium, particularly MgSO4 and more preferably anhydrous magnesium sulfate.

According to another advantageous embodiment, the mean diameter of the particles is comprised between 0.01 mm and 1 mm and more preferably between 0.01 mm and 0.3 mm, and more preferably still, between 0.01 mm and 0.1 mm.

Advantageously, the cavities are distributed substantially homogeneously through the elastomer material.

Again advantageously, the filling particles occupy between 15% and 60% of the volume of the outsole, and more preferably between 25% and 35% of the volume of the outsole.

The invention also provides for a method for manufacturing a shoe sole as described hereinabove, in which a plurality of filling particles are incorporated into an elastomer material and mixed therewith in order to constitute a substantially uniform mix, the mix obtained then being vulcanized in a mould in the form of an outsole specifically provided for that purpose.

This method makes it possible to manufacture soles as described hereinabove in a way that is simple and economical.

### DESCRIPTION OF THE FIGURES

All the embodiment details are given in the following description, supplemented by FIGS. 1 and 2, provided solely by way of non-limiting example, in which:

FIG. 1 is an enlarged schematic depiction of one example of a portion of an outsole comprising cavities and filling particles;

FIG. 2 is a schematic depiction of a cross section through one example of a sole of a shoe.

### DETAILED DESCRIPTION OF THE INVENTION

### Definitions

What is meant by “outsole” is the wearing sole, namely that part of the sole that is in contact with the ground.

What is meant by “midsole” or “middle sole” is that part of the sole that extends substantially under the entire foot, against the outsole, and between the latter and the insole or inner sole.

What is meant by “insole” or “inner sole” is that part of the sole in contact with the foot and underneath which the midsole and the outsole successively extend.

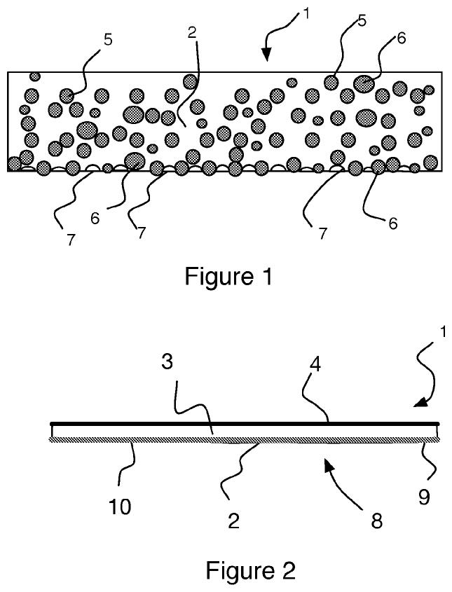

FIG. 2 illustrates one example of a shoe sole 1 according to the invention. This sole comprises an outsole 2, an insole 4 and a midsole 3 extending between the insole 4 and the outsole 2. FIG. 1 schematically illustrates an enlargement of an elevation of an outsole alone.

A plurality of filling particles 6 occupy part of the volume of the sole. At ambient temperature, these particles are in the solid state. Each one of the cavities is generally occupied by a single particle. Occasionally, several particles may occupy the one same cavity. The particles are distributed substantially uniformly through the body of the sole. The filling particles 6 occupy between 15% and 60%, and more preferably between 25% and 35%, of the volume of the outsole.

An unworn sole comprises a plurality of cavities. Those which are at the external surface 8 of the sole give rise to micro-reliefs, increasing the coefficient of friction of the sole. The edge corners produced by the open cavities brought to light at the surface of the sole contribute to increasing the coefficient of friction of the sole.

As the sole gradually wears, the cavities “in reserve” within the outsole progressively come to light. New micro-reliefs thus regularly appear, affording a high level of grip. Thus, despite wear, the advantageous properties of the sole are maintained without degradation in performance until such point as all of the cavities in reserve have been used up.

According to a first embodiment of the invention, the cavity 5 filling particles 6 are water-soluble. Thus, as the sole progressively wears, new cavities gradually come to light. The particles are then brought into contact with the environment. As soon as the sole encounters water or moisture, the particles are removed by dissolving.

According to a second embodiment, the particles are not necessarily water-soluble. They are then removed by a mechanical effect. The particles newly released, during phases of contact and friction with the ground, are ejected. Even if certain particles remain attached for longer, as the sole around them wears away, the retention effect lessens and the particles then leave the remaining cavity portions.

These two embodiments, which are advantageously combined, afford a self-regenerating effect, progressively bringing new cavities to light as the particles are released. This design makes it possible to ensure the durability of the grip properties associated with the cavities.

When released, the particles are removed from the cavities either by dissolving in a wet environment and/or by being torn out as a result of the friction of the sole against the ground. The micro-reliefs thus created may then come fully into contact with the ground. Each cavity then contributes to increasing the coefficient of friction. The high density of cavities brought to light at the surface of the sole contributes to producing a sole that exhibits particularly good grip.

Salts, preferably water-soluble salts, may be used to make the filling particles 6. Use is made, for example, of salts such as chlorates (NaCl) or perchlorates, or sulfates of potassium, ammonium or magnesium, particularly MgSO4 and more preferably anhydrous magnesium sulfate.

The mean diameter of the particles 6 is comprised between 0.01 mm and 1 mm and more preferably between 0.01 mm and 0.3 mm, and more preferably still, between 0.01 mm and 0.1 mm.

The invention also provides a method for manufacturing an outsole of a shoe as described in the preceding paragraphs.

One of the key phases of the method regards the incorporation into the raw elastomer compound of a plurality of filling particles 6. The elastomer material with the added particles are mixed in order to form a substantially uniform hybrid material.

The mixture obtained is then placed in a sole-shaped mould where it will be vulcanized. The vulcanizing temperatures and times are substantially the same as for a conventional sole.

The filling particles added to the elastomer material each occupy a volume which, during the vulcanizing phase, makes it possible to generate micro-cavities. These micro-cavities are distributed through the outsole. The presence of the particles makes it possible to form cavities without the need to use chemical additives that generate bubbles during the vulcanizing phase.

### REFERENCE NUMERALS EMPLOYED IN THE FIGURES

1 Sole
2 Outsole
3 Midsole
4 Insole
5 Cavities
6 Particles
7 Open cavities
8 External surface of the outsole
9 Heel
10 Region of the upper

1.-9. (canceled)

10. A shoe sole comprising:
an outsole;
an insole; and
a midsole, extending between the insole and the outsole,
wherein the outsole is made of an elastomer material comprising a plurality of cavities filled with cavity-filling particles which are in the solid-state at ambient temperature,
wherein a plurality of open cavities form micro-reliefs distributed over an external surface of the outsole when new, and
wherein new open cavities are exposed on the external surface of the outsole due to a distribution of filled cavities throughout the outsole and due to wear.

11. The shoe sole according to claim 10, wherein the cavity-filling particles are water-soluble.

12. The shoe sole according to claim 10, wherein the cavity-filling particles are salts.

13. The shoe sole according to claim 10, wherein the cavity-filling particles are selected from the group consisting of chlorates, perchlorates, and sulfates of potassium, ammonium and magnesium.

14. The shoe sole according to claim 13, wherein the cavity-filling particles comprise MgSO₄.

15. The shoe sole according to claim 14, wherein the cavity-filling particles comprise anhydrous magnesium sulfate.

16. The shoe sole according to claim 10, wherein a mean diameter of the cavity-filling particles is between 0.01 mm and 1 mm.

17. The shoe sole according to claim 16, wherein the mean diameter of the cavity-filling particles is between 0.01 mm and 0.3 mm.

18. The shoe sole according to claim 17, wherein the mean diameter of the cavity-filling particles is between 0.01 mm and 0.1 mm.

19. The shoe sole according to claim 10, wherein the filled cavities are distributed substantially homogeneously through the elastomer material.

20. The shoe sole according to claim 10, wherein the cavity-filling particles occupy between 15% and 60% of a volume of the outsole.

21. The shoe sole according to claim 10, wherein the cavity-filling particles occupy between 25% and 35% of a volume of the outsole.

22. A method for manufacturing a shoe sole according to claim 10, the method comprising:
incorporating a plurality of cavity-filling particles into the elastomer material;
mixing the plurality of cavity-filling particles and the elastomer material in order to form a substantially uniform mix; and
vulcanizing the substantially uniform mix in a mold in a form of an outsole.
